(19) United States
(12) Patent Application Publication
(10) Pub. No.: US 2025/0389153 A1
(43) Pub. Date: Dec. 25, 2025

(54) SPACER PANEL ASSEMBLY FOR ROLLER SHUTTERS

(71) Applicant: Igor Egudkin, Kleinburg (CA)

(72) Inventor: Igor Egudkin, Kleinburg (CA)

(21) Appl. No.: 19/073,559

(22) Filed: Mar. 7, 2025

(30) Foreign Application Priority Data
Jun. 25, 2024 (CA) 3245119

(51) Int. Cl. E06B 9/15; E06B 9/17

(52) U.S. Cl. CPC E06B 9/15; E06B 9/17; E06B 2009/1505

(57) ABSTRACT

The roller shutter assembly is formed by a plurality of panels slidably received in a plurality of spacers all in an alternating fashion to form an elongate covering movable between a rolled and unrolled position. A connector extends between a connecting end of elongate covering, opposite a locking end, to connect to a rotatable shaft such that rotation of the shaft in one direction lifts the covering into a rolled position, and rotation of the shaft in the opposite direction drops the elongate covering into an unrolled position.

The panels increase in width from the connecting end to the locking end, such that in the rolled position, the spacers nest together to stack and space apart the panels thereby limiting panel interaction. In the rolled position, the spacers nest together in layers with the intermediate panel possessing an intermediate width relative to adjacent panels to connect adjacent layers.

### CROSS REFERENCE TO RELATED PATENT APPLICATIONS

This patent application claims the benefit of and priority to Canadian Patent Application No. 3,245,119, filed on Jun. 25, 2024, the entire contents of each of which are incorporated herein by reference for all purposes.

### FIELD OF INVENTION

The present invention relates generally to roller shutters and specifically, to retractable roller shutter assemblies for exterior use.

### BACKGROUND OF THE INVENTION

Roller shutters are typically used in various locations to offer certain advantages such as security, noise reduction, energy efficiency, weather protection, privacy, and the like. They can be installed as a barrier for use in windows and doors. In commercial applications, roller shutters can protect assets and inventory, such as service counters, kiosks, storage, and shelving units, among others. In residential locations, these uses can also be for windows, doors, and other openings to assist with light control, energy savings, and other benefits.

In these uses, the roller shutters are typically metal panels that interconnect and can roll upwards into a closed position or unroll into an open position. When unrolled in an open position, these roller shutters provide a barrier between the interior and exterior. They can be used in conjunction with existing doors, windows, or openings to enhance security, increase energy efficiency, dampen noise, and offer a range of other advantages. When rolled into a closed position, the panels typically roll together into a generally tubular shape. When rolled, the panels typically touch or abrade together as they roll into the tubular shape and may fit within a casing or box. As security measures, these roller shutters are typically metal panels offering no visibility on either side of these roller shutters. For example, when installed on the exterior windows, one cannot see inside or outside. Consequently, entirely metal roller shutters may not necessarily always be visually appealing.

One solution is to have transparent panels to allow for visibility from either side of the roller shutter while providing the benefits of added security, sound insulation, protection against inclement weather, or other benefits. However, these panels can run against each other during the rolling process and while in the rolled position. This interaction can result in panels abrading each other. For certain materials, such as transparent panels, this abrasion can create undesirable scratches and visual defects within the panels. Thus, there is a need for a more effective solution to the issues above that can for example, provide visually appealing rolling shutters while minimizing the risk of damage to the panels during the rolling and unrolling process.

### SUMMARY OF THE INVENTION

It is an object of the invention to provide an improved roller shutter assembly.

According to an aspect of the present invention, a plurality of spacers is provided, and each spacer has an elongated body defined by a front spacer face having an outward curvature opposing a rear spacer face having an inward curvature. These front and rear spacer faces are disposed between a first end opposite a second end of the elongated body. Each spacer also has channeled sides running from the first end to the second end for interconnecting the front and rear spacer faces.

A plurality of panels is also provided, with each panel defined by a front panel face opposite a rear panel face. Each of the panels has a generally rectangular profile with four corner portions defined by two opposing side edges adjacent two opposing connecting edges. The connecting edges have a groove in the rear panel face that runs longitudinally along the connecting edge for slidably engaging the respective channeled side of the spacer for limiting lateral outward movement of the panel. The channeled sides each have a narrow opening and an enlarged cavity to allow for flexible rotatable movement of each slidably engaged panel. The plurality of panels and plurality of spacers interconnect in an alternating manner to form an elongate covering having a connecting end opposite a locking end.

### BRIEF DESCRIPTION OF THE DRAWINGS

These and other features of the invention will become more apparent from the following description in which reference is made to the appended drawings wherein:

FIG. 1A shows a perspective view of a section of an exemplary roller shutter assembly in a rolled position in accordance with an embodiment of the present invention;

FIG. 1B shows the section of the exemplary roller shutter assembly of FIG. 1A with the stopper removed;

FIG. 1C shows an end elevation view of the section of FIG. 1B;

FIG. 2A shows a perspective view of the exemplary roller shutter assembly of FIG. 1A in a partially unrolled position;

FIG. 2B shows a perspective view of the section of the exemplary roller shutter assembly of FIG. 1A in a further unrolled position;

FIG. 3A shows a rear perspective view of a spacer of the exemplary roller shutter assembly of FIG. 1A;

FIG. 3B shows a front perspective view of the spacer of FIG. 3A;

FIG. 4 shows a perspective view of an exemplary spacer with a webbing in accordance with an embodiment of the present invention;

FIG. 5 shows a perspective view of another exemplary spacer with a solid body in accordance with an embodiment of the present invention;

FIG. 6A shows a rear perspective view of the panel of the roller shutter assembly of FIG. 1A;

FIG. 6B shows a perspective view of the panel of FIG. 6A slidably receiving exemplary spacers;

FIG. 7 shows an end view of the panel and spacer of FIG. 1B interacting;

FIG. 8 shows a top plan view of an exemplary guide of the roller shutter assembly of FIG. 1A;

FIG. 9A shows a perspective view of the exemplary guide of FIG. 8 receiving an exemplary spacer;

FIG. 9B shows a perspective view of the guide of FIG. 8 receiving an exemplary spacer and exemplary panel;

FIG. 10 shows a perspective view of the roller shutter assembly of FIG. 1A in an unrolled position attached to a rotatable shaft; and

FIG. 11 shows a perspective view of the roller shutter assembly of FIG. 10 with a casing for receiving the shutter assembly.

### DETAILED DESCRIPTION

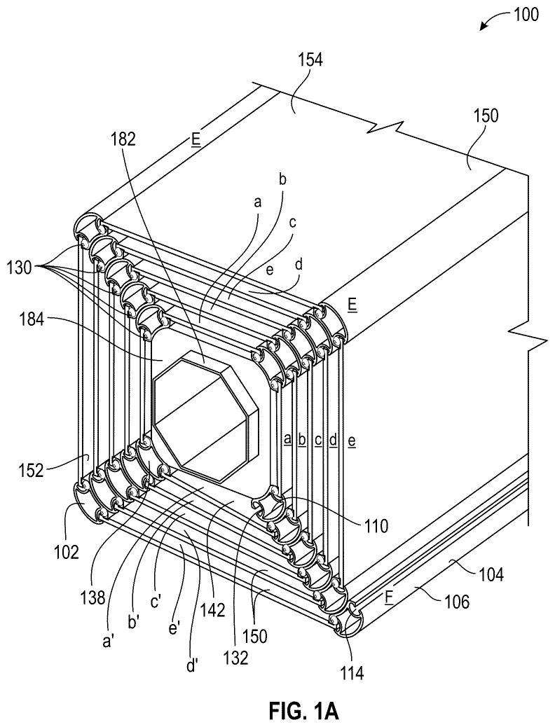

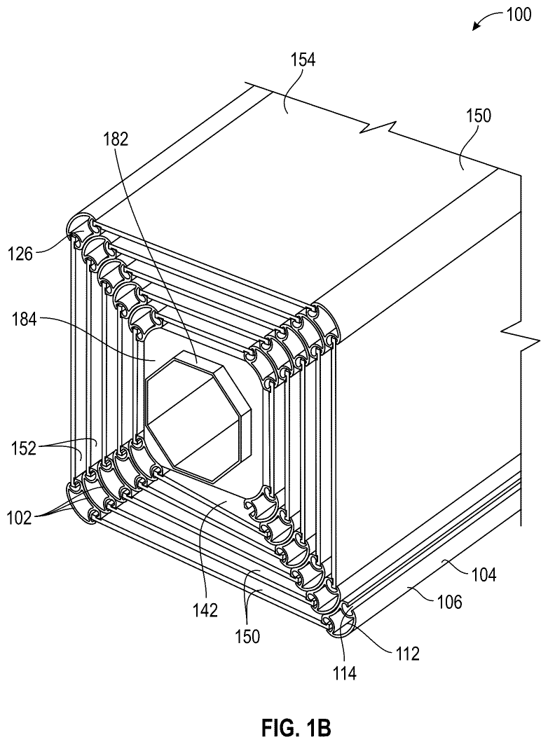

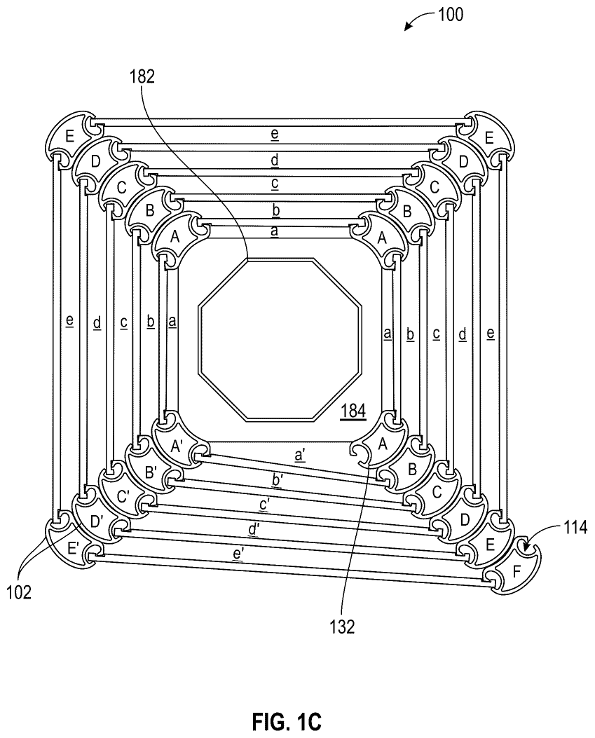

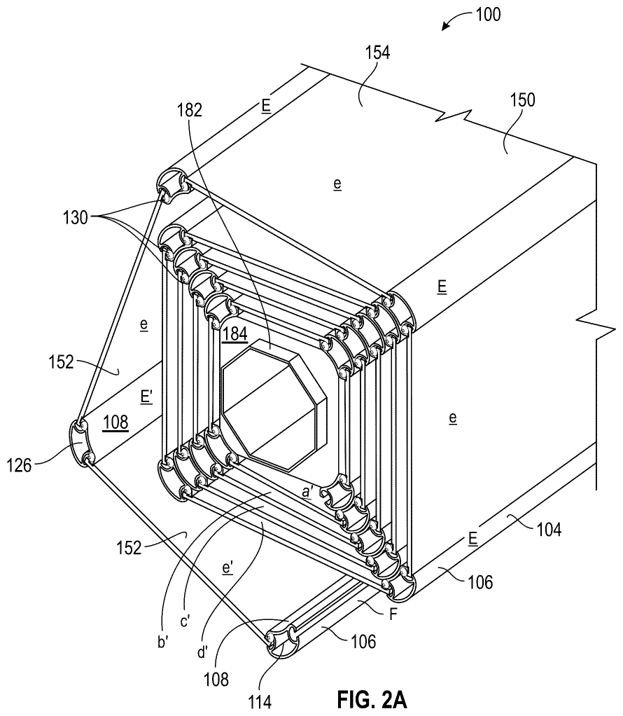

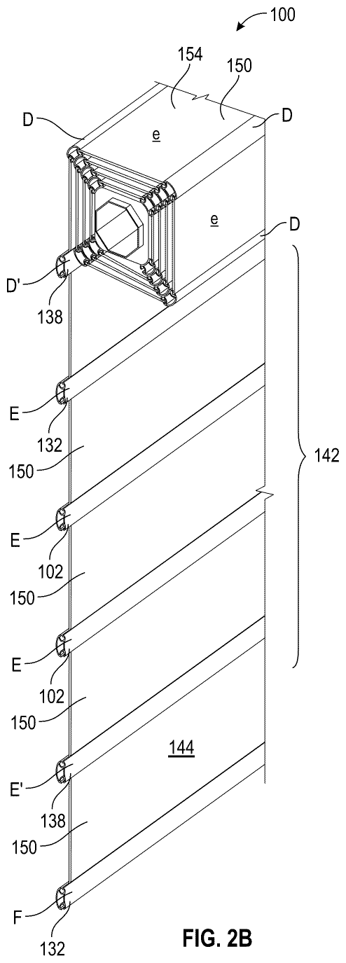

Reference is made to FIGS. 1A-2B, in which a section of an illustrative roller shutter assembly movable between a closed rolled position and an open unrolled position is provided, indicated generally by the reference numeral 100. The roller shutter assembly 100 broadly comprises a plurality of spacers 102 and a plurality of panels 150 interconnecting in an alternating manner to form an elongate covering 170 having a connecting end 172 opposite a locking end 174. The number of panels and spacers can be fewer or greater to accommodate differing desired lengths of the elongate covering 170. For example, fewer panels and spacer combinations may be used to provide for a shorter elongate covering. Alternatively, additional panels and spacers may be added in an alternating manner to provide for a longer elongate covering.

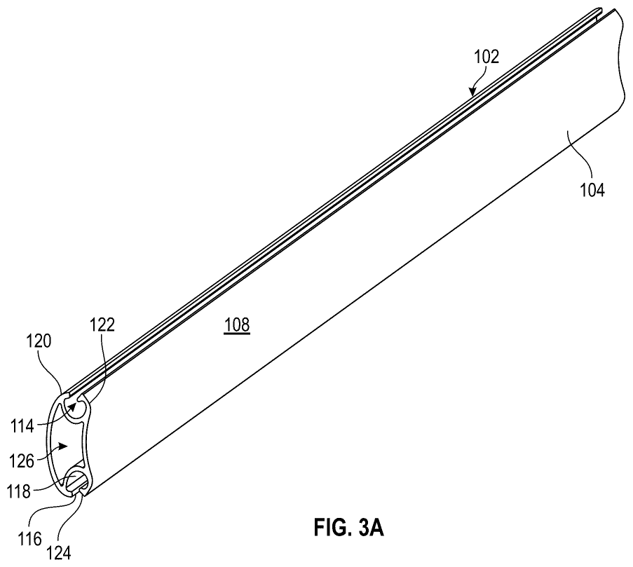

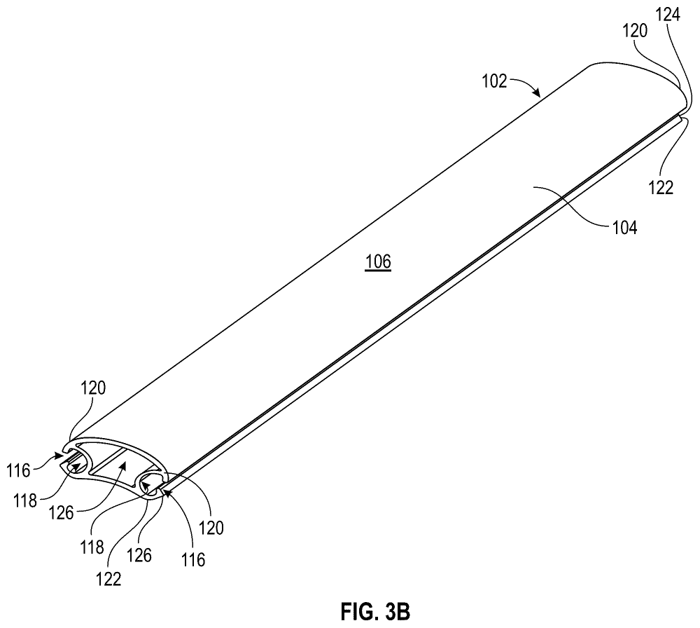

Reference is now made to FIGS. 3A-3B. Each spacer 102 features an elongated body 104, defined by a front spacer face 106 with an outward curvature opposing a rear spacer face 108, which has an inward curvature. The front and rear spacer faces 106, 108 are disposed between a first end 110 and a second end 112. The spacer has channeled sides 114 running longitudinally from the first end 110 to the second end 112 that interconnect the front and rear spacer faces 106, 108. The channeled sides 114 also slidably receive the panels 150 (described below).

As shown more clearly in FIGS. 2A, 6A-7, each panel 150 defines a front panel face 152 opposite a rear panel face 154. Each panel 150 has a generally rectangular profile having four corner portions 158 defined by a pair of opposing side edges 160a adjacent a pair of opposing connecting edges 162a. The rear panel face 154 has a groove 164 running longitudinally along the connecting edge 162a, for slidably engaging the respective channeled side 114 for limiting lateral outward movement of the panel 150.

To provide for visibility on either side of the elongate covering, the panels may be made of a clear material such as plastic or glass. It may be formed of polycarbonate, for example, extruded polycarbonate. Alternatively, if visibility is not needed, it may be formed of an opaque material. The panels may also be found in different colours, tints, or opacities as desired and as known to one skilled in the art.

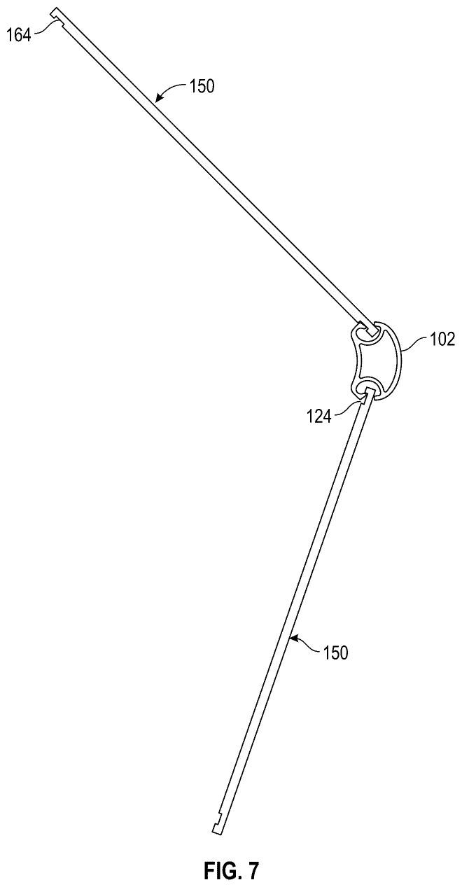

To allow for flexible rotatable movement of each slidably engaged panel 150, the channeled sides 114 have a narrow opening 116 and an enlarged cavity 118 as can be seen more clearly in FIG. 7.

In one embodiment, the channeled sides 114 are strut channels as shown more clearly in the accompanying FIGS. 3A-3B. The strut channels are defined by an inwardly facing front lip 120 that extends from the front spacer face 106 and an inwardly facing rear lip 122 that extends from the rear spacer face 108. The inwardly facing front lip 120 and rear lip 122 define the narrow opening 116 and enlarged cavity 118 of the channeled sides 114. The rear lip 122 may have a chamfered edge 124 for interfacing with panels. Thus, during flexible rotatable movement, the chamfered edge 124 may register with the groove 164 of the panel 150.

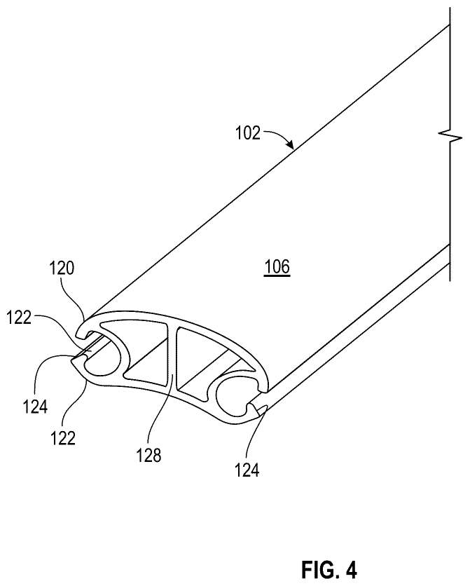

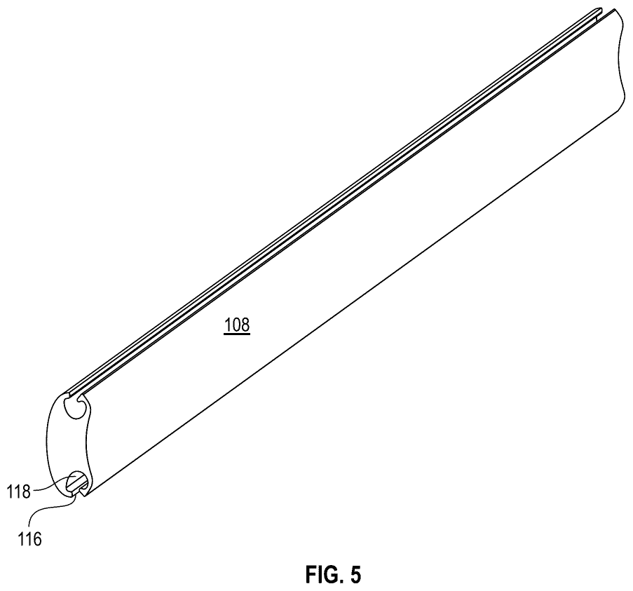

The spacer 102 may be hollow as shown in FIGS. 1A-3B. Alternatively, the spacer may be solid as shown in FIG. 5, partially hollow, or some other combination. In some embodiments, the spacer 102 may have webbing 128 added in the hollow body 126 for added structural support as shown in FIG. 4. Other variations are also possible as will be readily known to a person skilled in the art.

To limit longitudinal outward movement of the panel 150, the roller shutter assembly 100 also has a stopper 130 as shown more clearly in FIG. 1A. The stopper is receivable in each channeled side 114 of the spacer 102 for interacting with the side edge of the panel 160a and for limiting longitudinal outward movement of the panel 150.

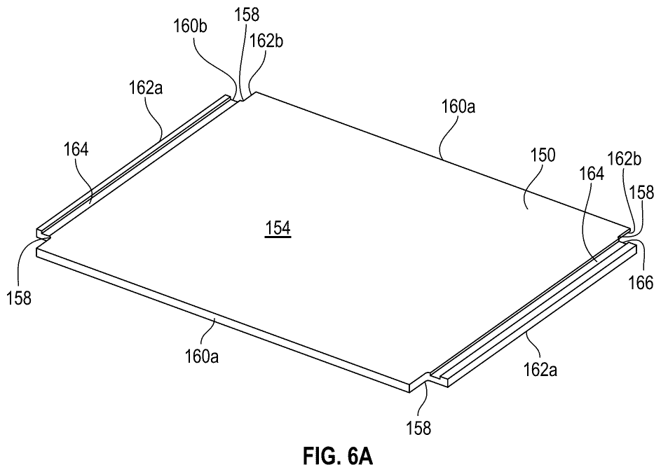

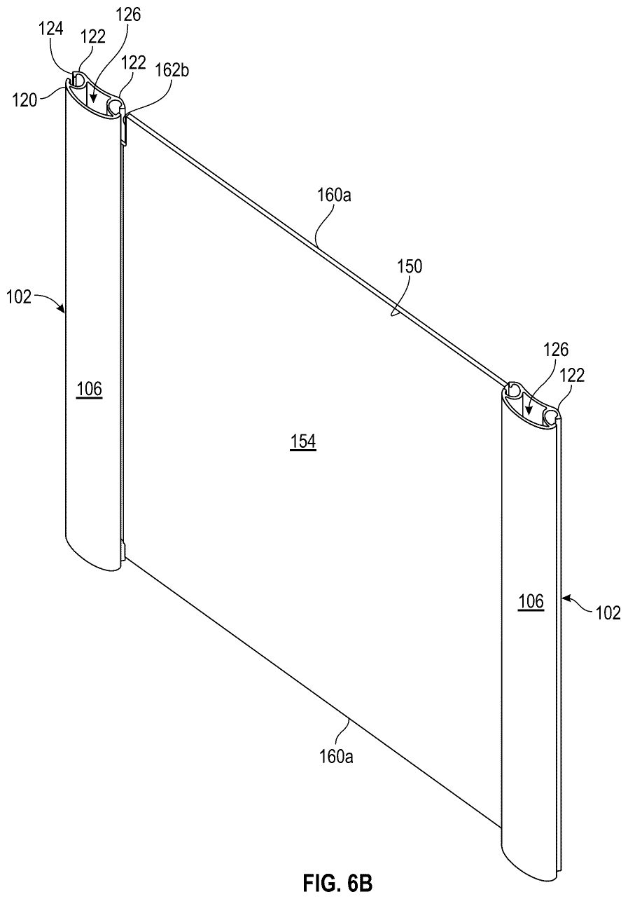

The panel 150 may have a notch 166 in the corner portions 158 of the rectangular profile of the panel 150 for receiving the stopper 130. This notch 166 in the corner portions 158 can be more clearly seen in FIGS. 6A and 6B. The notch 166 defines an intended side edge 160b generally parallel to the side edge 160a and an indented connecting edge 162b generally parallel to the connecting edge 162a. With the presence of a notch 166, the stopper 130, then, interacts with the indented side edge 160b of the panel rather than with the side edge 160a for limiting longitudinal outward movement of the panel.

To provide a generally linear profile of the spacer, stopper, and panel, the notch 166 may be sized to correspond to the size of the stopper 130. In this way, the stopper 130 is inserted into a channeled side 114 of the spacer 102. Once inserted, it interacts with the indented side edge 160b of the panel 150 to limit the outward longitudinal movement of the panel 150. Specifically, the panel 150 does not continue sliding through the channel and is instead stopped by the interaction with the stopper 130. Thus, the inserted end of the stopper 130 interacts with the panel's indented side edge 160b, and the stopper 130 is generally the same length as the notch 166 to remain flush with the spacer second end 112 and panel side edge 160a.

The stopper, as shown, may be a threaded screw. Alternatively, it may be a plug, cap, rivet, pin, top, or any other filler as known to one skilled in the art. It may have a head, as shown in the screw or may be headless so long as it fits to limit outward movement. It may be made of metal, cork, foam and may be tapered or otherwise, wood, or any other suitable material or shape as will be known to one skilled in the art.

Referring to FIGS. 2B, 10 and 11, the elongate covering 170 rotates around a rotatable shaft 182. Thus, in an unrolled position, the rotatable shaft 182 may be seen more clearly. To lift the elongate covering 170 into a rolled position, a connecting member 180 may extend between the connecting end 172 of the elongate covering 170 and the rotatable shaft 182 around which the elongate covering rotates. Thus, upon manual or motorized operation, the rotatable shaft 182 may rotate in one direction along with the connecting member 180 which lifts and rolls the elongate covering 170. Upon manual or motorized operation, the rotatable shaft 182 may rotate in the opposite direction along with the connecting member 180 which drops and unrolls the elongate covering 170. The connecting member 180 may be integral with either or both of the rotatable shaft, the connecting end 172. The connecting member 180 may also be a flexible I-bar formed of multiple connected pieces, as is generally shown. Alternatively, it may be an integral piece or fewer or more pieces. The material choice of the connecting member may also be aluminum, flexible plastic, or any other suitable material, as known to one skilled in the art

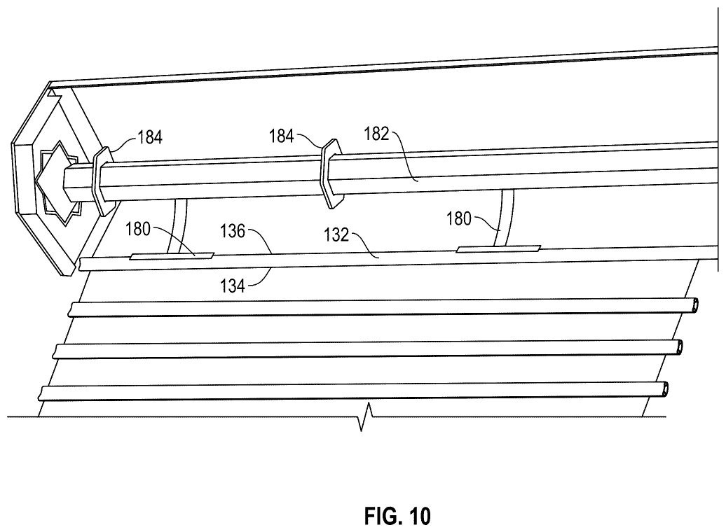

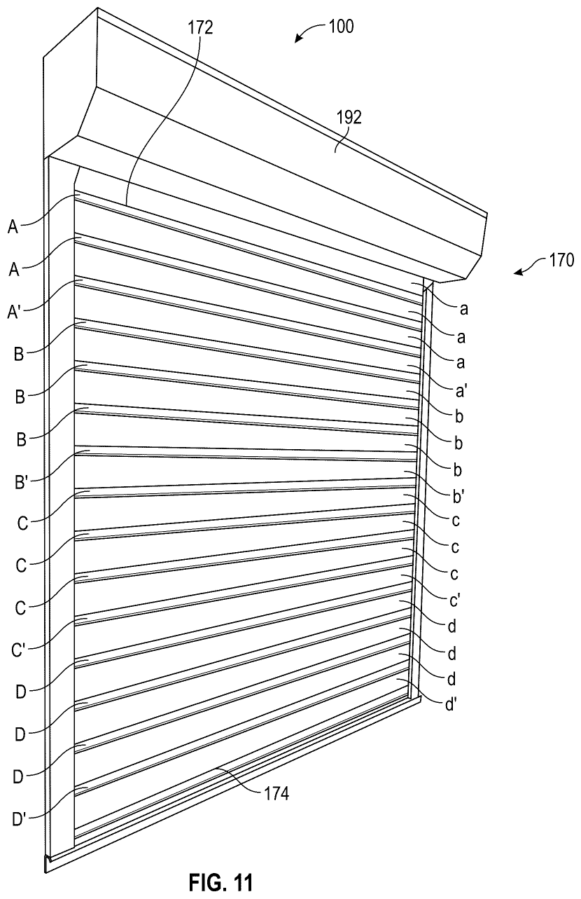

To limit the risk of interaction between panels that could result in damage or scratching in the rolled position, the elongate covering is rolled so that the spacers nest together in the rolled position, and the panels are thus stacked spaced apart. The panels 150 increase in width from the connecting end 172 to the locking end 174 for stacking the panels 150 and nesting the spacers 102 in the rolled position. This allows the spacers 102 to nest together, abutting the rear spacer face 108 to the front spacer face 106 of nesting spacers 102. The length of the panels remains the same. In an unrolled position, for example, the widening panels may be seen in FIGS. 10 and 11. With the spacers 102 nesting, the panels 150 then remain spaced apart, limiting the risk of scratching and damage to the panels 150.

To allow the spacers to nest together, at least one panel set 141 formed of sequentially placed panels 150 with a shared width interconnects the spacers 102 of a single layer. At least one intermediate panel 144 having a greater relative width interconnects a terminal spacer 138 of the single layer with an initial spacer 132 of an adjacent layer. The initial spacer 132 of the single layer nests with the initial spacer 132 of the adjacent layer. The number of layers could vary depending on the desired length of the elongate covering 170. Thus, a greater number of layers could result in a longer elongate covering, each layer interconnected by an intermediate panel 144.

Referring now to FIGS. 1A-1B, one embodiment of the nesting spacers and stacked panels forming a generally rectangular configuration of the elongate covering in the rolled position can be seen. Here, the panel set 141 having a shared width could be three panels as shown as: a, a, a or b, b, b or c, c, c, etc. where the panel set defined by panels a, a, a share a width, the panel set defined by panels b, b, b share a width, and the panel set defined by panels c, c, c share a width and so on. Therefore, each of the panels in a single panel set has a shared width, and each panel of a single panel set interconnects the spacers 102 of the single layer.

As seen in the accompanying drawings, the single layer of spacers is formed by four spacers. Therefore, for the first layer, this could be the initial spacer 132 and subsequent spacers abutting the guide fitted around the rotatable shaft (described below); thus, the spacers of the first layer are shown as A, A, A, A′, with A′ being the terminal spacer of the first layer. The initial spacer of the second layer nests with the initial spacer of the first layer, and the subsequent spacers of the second layer nest with the respective spacers of the first layer. The spacers of the second layer are shown as B, B, B, B′ with B′ being the terminal spacer of the second layer. Thus, these spacers nest together such that A′ abuts with B′, which abuts with C′ and so on.

As can be seen in the accompanying figures, the initial spacer 132 of the first layer (A) has a panel receiving channel 134 for receiving the panel a. The opposing channel 136 may be a connector channel for receiving the connecting member 180 if that is how the joining occurs. Alternatively, the connecting member 180 may be engaged in a different way with the initial spacer 132.

An intermediate panel 144 with a greater width relative to the panel set of the first layer (and less than the panel set of the second layer) connects the terminal spacer 138 of the first layer A′ with the initial spacer 132 of the second layer B. The intermediate panel 144 (e.g., a′, b′, c′, d′ and so on) has an intermediate width relative to the panel set that immediately precedes it and panel set that immediately follows it because the intermediate panel joins spacers of different layers and thus are at an angle. Thus, the intermediate panel of the first layer (labeled a′) joins the terminal spacer of the first layer (labeled A′) with the initial spacer of the second layer (labeled B). In this rectangular rolled configuration, the panel set of the first layer (a) generally follows in a parallel fashion to the guide perimeter 188. The intermediate panel (a′) that follows, however, interconnects the terminal spacer (A′) of the first layer to the spacer (B) of the second layer. As the intermediate panel (a′) connects different layers, it is slightly obtusely angled relative to the guide perimeter 188 to reach spacer (B) of the second layer and thus, possesses a greater width relative to the width of the panels that immediately precede it that interconnect spacers of the same layer. The intermediate panel (a′), then, is not co-planar with the guide 184.

Similarly, the intermediate panel (b′) of the second layer interconnects the terminal spacer of the second layer (B′) to the initial spacer of the third layer (C). Therefore, the intermediate panel (b′) is also slightly obtusely angled relative to the guide perimeter 188 to reach the spacer (C) of the third layer. Although not following in parallel to the guide perimeter 188, the intermediate panel (b′) does stack in a co-planar fashion with the remaining intermediate panels. Accordingly, each of the intermediate panels possesses a width greater than the panel set that immediately precedes it and lesser than the panel set that immediately follows it.

Reference is now made to FIGS. 1A-1B and FIGS. 10 and 11 to describe the structure in one embodiment at the connecting end 172 and the locking end 174 of the elongate covering. In one embodiment, a connecting spacer is shown as reference numeral 132, which is found at the connecting end 172 of the elongate covering. The connecting spacer 132 slidably receives a panel in only one channeled side denoted as 134, the panel receiving channel. The opposite channeled side denoted as 136, the connector channel, engages with the connecting member 180. This engagement may be a similar interlocking engagement with the grooved panel slidably engaging the channeled spacer; alternatively, it may be a press fit engagement; alternately, it may be secured by bolting or any other manner of securement as will be known to one with skill in the art.

The locking end 174 of the elongate covering 170 may be a terminal spacer 142 which is locked using known locking mechanisms. For example, the locking end 174 may have a rubber seal as a standard element of a conventional roller shutter as will be known to one with skill in the art. Any suitable locking mechanism as known to one with skill in the art may be used.

The roller shutter assembly in the rolled position may also be receivable a casing 192 as best shown in FIG. 11. This casing may be fitted around the rotatable shaft.

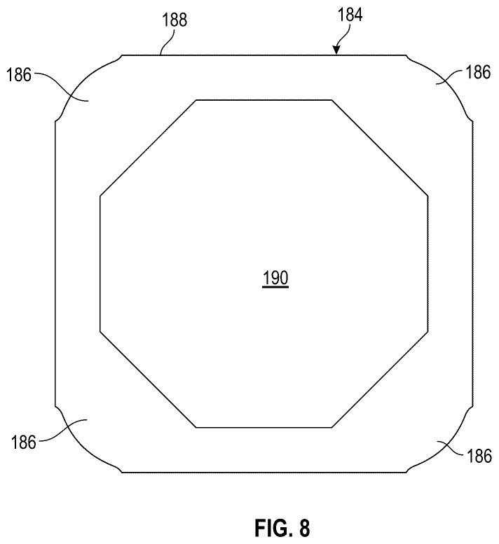

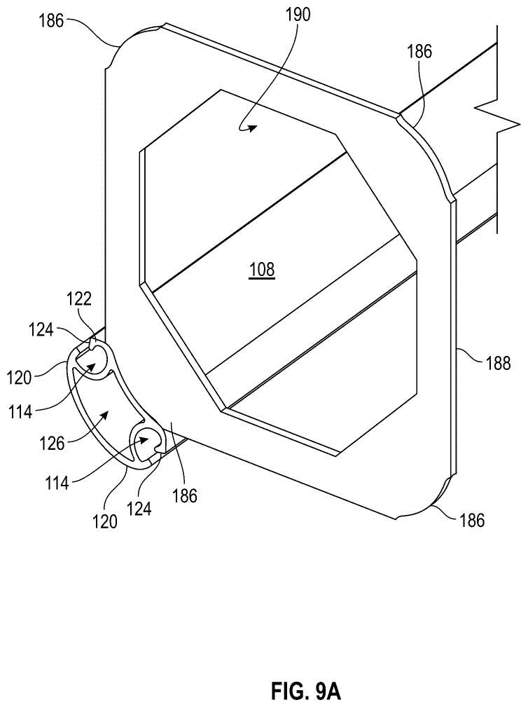

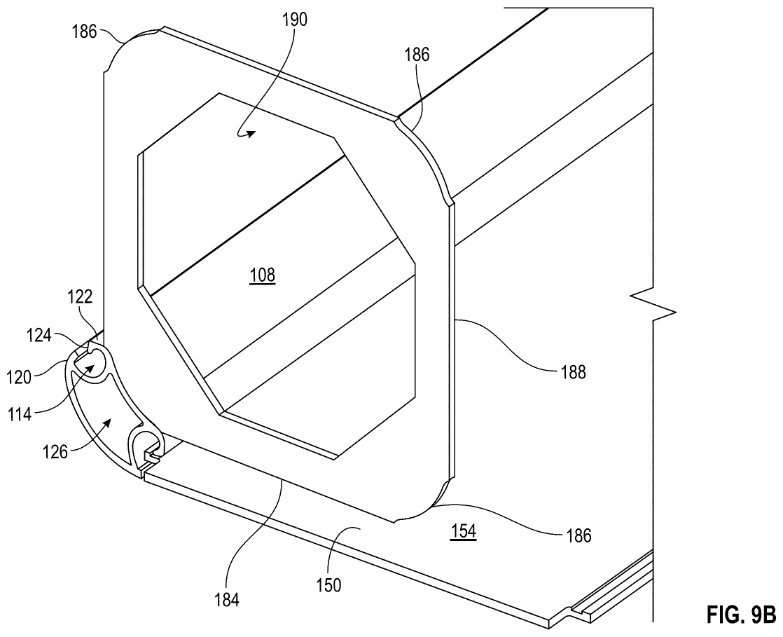

Referencing now FIGS. 1A-2B, 8-9B, and 10, at least one guide 184 may be fitted around the rotatable shaft 182 for receiving the plurality of spacers 102 in a stacked formation with the front spacer face 106 of at least some of the spacers interfacing with the rear spacer face 108 of at least some of the spacers in the rolled position. The guide 184 may have a generally rectangular perimeter 188, having four corner sections 186. Each of the corner sections 186 is shaped to correspond to the shape of the rear spacer face 108 to snugly interface with the rear spacer face 108 in a rolled position for nesting together. To provide for fitting around the rotatable shaft 182, the guide 184 has an aperture 190 generally corresponding in shape to the shape of the rotatable shaft. Thus, if the rotatable shaft is octagonal, the aperture 190 of the guide is similarly octagonal as can be seen clearly in FIGS. 1A and 1B. Alternatively, the rotatable shaft may be hexagonal, rectangular, circular, or any of myriad shapes as known to one skilled in the art. The aperture of the guide then would similarly correspond to such shape to provide for securely fitting around the rotatable shaft. As shown in FIG. 10, more than one guide may be placed around the rotatable shaft in a spaced-apart manner to receive the rear face of the spacer at different touchpoints of the rear spacer face 108.

One or more currently preferred embodiments have been described by way of example. It will be apparent to persons skilled in the art that a number of variations and modifications can be made without departing from the scope of the invention as defined in the claims.

What is claimed is:

1. A roller shutter assembly movable between a rolled position and unrolled position, said roller shutter assembly comprising:
a plurality of spacers, each spacer having an elongated body defined by a front spacer face with an outward curvature opposing a rear spacer face having an inward curvature;
said front and rear spacer faces disposed between a first end opposite a second end;
each spacer having channeled sides running from said first end to said second end interconnecting the front and rear spacer faces; and
a plurality of panels, each panel defining a front panel face opposite a rear panel face,
each panel having a generally rectangular profile having four corner portions defined by two opposing side edges adjacent two opposing connecting edges;
a groove in said rear panel face running longitudinally along said connecting edge for slidably engaging the respective channeled side of the spacer for limiting lateral outward movement of said panel;
wherein said channeled sides have a narrow opening and an enlarged cavity for flexible rotatable movement of each slidably engaged panel; and
wherein said plurality of spacers and said plurality of panels interconnect in an alternating manner to form an elongate covering having a connecting end opposite a locking end.

2. The roller shutter assembly of claim 1, further comprising a connecting member extending between said connecting end of the elongate covering and a rotatable shaft around which said elongate covering rotates.

3. The roller shutter assembly of claim 1, wherein said panels increase in width from said connecting end to said locking end for stacking the panels and nesting the spacers in the rolled position.

4. The roller shutter assembly of claim 3, wherein in the rolled position, at least one panel set formed of sequentially placed panels with a shared width interconnect the spacers of a single layer and at least one intermediate panel having a greater relative width interconnects a terminal spacer of the single layer with an initial spacer of an adjacent layer, said initial spacer of the single layer nesting with said initial spacer of the adjacent layer.

5. The roller shutter assembly of claim 4, wherein the nesting spacers and the stacked panels form a generally rectangular configuration of the elongate covering in the rolled position.

6. The roller shutter assembly of claim 1, further comprising a stopper receivable in each channeled side of the spacer for interacting with said side edge of the panel and for limiting longitudinal outward movement of said panel.

7. The roller shutter assembly of claim 6, further comprising a notch in each corner portion of the rectangular profile of said panel for receiving said stopper, said notch defining an indented side edge generally parallel to said side edge and an indented connecting edge generally parallel to said connecting edge, wherein said stopper interacts with said indented side edge for limiting longitudinal outward movement of said panel.

8. The roller shutter assembly of claim 7, wherein said notch is sized to correspond to the size of said stopper for providing a generally linear profile of the spacer, stopper, and panel.

9. The roller shutter assembly of claim 7, wherein said stopper is a screw.

10. The spacer of claim 1, wherein said channeled sides of the spacer are strut channels defined by an inwardly facing front lip extending from the front face and an inwardly facing rear lip extending from the rear face.

11. The spacer of claim 10, wherein said rear lip has a chamfered edge for interfacing with panels.

12. The spacer of claim 1, wherein said elongated body is hollow.

13. The spacer of claim 12, further comprising webbing in the hollow elongated body for added structural support.

14. The roller shutter assembly of claim 1, wherein said panel is formed of polycarbonate.

15. The roller shutter assembly of claim 1, further comprising at least one guide fitted around said rotatable shaft for receiving said plurality of spacers in a nesting formation with the front spacer face of at least some of the spacers interfacing with the rear spacer face of at least some of the spacers in the rolled position.

16. The roller shutter assembly of claim 1, wherein said guide has a guide perimeter that is generally rectangular with four corner sections shaped to correspond to the shape of said rear spacer face to snugly interface with said rear spacer face in a rolled position for nesting the spacers together.
